(19) United States
(12) Patent Application Publication
(10) Pub. No.: US 2010/0005977 A1
(43) Pub. Date: Jan. 14, 2010

(54) UNIVERSAL FOOD PROCESSOR

(75) Inventor: David Menashes, Haifa (IL)

Correspondence Address: William H. Dippert;Eckert Seamans Cherin & Mellott, LLC, U.S. Steel Tower, 600 Grant Street, 44th Floor, Pittsburgh, PA, 15219, US

(73) Assignee: Tichkum Distribution of Advanced Consumer Products Ltd., Haifa (IL)

(21) Appl. No.: 12/523,462

(22) PCT Filed: Jan. 17, 2008
(86) PCT No.: PCT/IL2008/000074

§ 371 Date: Jul. 16, 2009

Related U.S. Application Data
(60) Provisional application No. 60/880,623, filed on Jan. 17, 2007.

(51) Int. Cl. A47J 43/06

(52) U.S. Cl. 99/510

(57) ABSTRACT

A multi-functional food processor comprises a bowl (10) having an upper opening and a base (12) and a cover (18) provided with a motor and having an opening sized to fit said upper opening. The multi-functional food processor is further provided with a plurality of utensils, each of the utensils having a shaft capable of receiving rotational power from the motor in the cover and a lower portion capable to fit onto said base.

### FIELD OF THE INVENTION

The present invention relates to food processors and choppers. More particularly, the present invention relates to a universal food processor that has a universal receiving bowl into which multiple of utensils having multiple purposes is incorporated.

### BACKGROUND OF THE INVENTION

There are many acts made in the kitchen while for every act, a specific utensil is provided. As examples, there are choppers provided with different blades for different vegetables wherein the same bowl is used for all kinds of blades. A known food processor that is used for many years all over the world is the Magimix having several functionalities for which different blades can be incorporated in the same apparatus. All blades are operated by the same rotating stem while the different blades are adapted for cutting vegetables, chopping them, chopping meat or other food materials, mixing food materials in order to produce matter such as dough etc. In trying to incorporate new functionalities to the apparatus in order to use the same engine for example, adjunct parts were added to the basic apparatus on its opposite side.

Small sized apparatii having several functionalities were also developed over the years wherein each of the developed devices is adapted for a limited number of operations. As example, there are devices that have hand held engine that can be incorporated within a mixing arm and a chopping arm, both provided with different bowls, or even the chopping arm can be freely used in the dish the materials are held in. Another example is disclosed in GB patent no. 190225497 in which there are disclosed improvements in apparatus for molding, mincing, grating, and grinding food preparations and the like.

As kitchen activities are developed and the kitchen is becoming one of the most important parts in the house where adults, teenagers and even kids are experiencing cooking activities, it is desired to develop food processors and choppers that have several functionalities in the same apparatus without the need to maintain several machines, each provided with a limit number of functionality.

### SUMMARY OF THE INVENTION

It is an object of the present invention to provide a universal food processor that has many functionalities, all provided in the same apparatus.

It is another object of the present invention to provide a universal food processor that has a universal bowl mounted on a single engine adapted to receive multiple of utensils for any operation that is taken in a kitchen.

It is yet another object of the present invention to provide a universal food processor that is compactly designed and having utensils that are easily replaces and exchanged.

It is therefore provided in accordance with a preferred embodiment of the present invention to provide a multi-functional food processor comprising:
a bowl having an upper opening and a base;
a cover provided with a motor and having an opening sized to fit said upper opening;
a plurality of utensils, each of the utensils having a shaft capable of receiving rotational power from said motor and a lower portion capable to fit onto said base.

Furthermore and in accordance with a preferred embodiment of the present invention, said base is provided with a stem capable of receiving said lower portion of each one of said plurality of utensils.

Furthermore and in accordance with a preferred embodiment of the present invention, said cover is provided with an on/off knob that controls the motor's operation.

Furthermore and in accordance with a preferred embodiment of the present invention, an extension to said bowl is provided in order to enlarge the bowl volume.

Furthermore and in accordance with a preferred embodiment of the present invention, said lower portion is placed within a rounded plate fitting said base.

Furthermore and in accordance with a preferred embodiment of the present invention, one of said plurality of utensil is a beater comprising a plurality of arcs placed in a circular manner around said shaft.

Furthermore and in accordance with a preferred embodiment of the present invention, at least one cutting blade is provided to be installed on top of said lower portion of the shaft.

Furthermore and in accordance with a preferred embodiment of the present invention, one of said plurality of utensils is a dasher comprising a holed paddle.

Furthermore and in accordance with a preferred embodiment of the present invention, a dish is provided to said dasher and wherein said dish is shaped as a cup and fits said base.

Furthermore and in accordance with a preferred embodiment of the present invention, one of said plurality of utensils is an ice crusher that comprises a blade capable of rotating within the bowl and a dish mounted in said bowl having side openings through which appropriate sized ice particles can be dispensed of the dish.

Furthermore and in accordance with a preferred embodiment of the present invention, a holed disc is provided in the bottom of said shaft.

Furthermore and in accordance with a preferred embodiment of the present invention, at least one paddle is provided on said shaft.

Furthermore and in accordance with a preferred embodiment of the present invention, one of said plurality of utensils is a peeler capable of peeling a peel of a garlic clove or nuts.

Furthermore and in accordance with a preferred embodiment of the present invention, said peeler comprises a balloon provided with a friction wall is provided on said shaft and wherein said balloon can freely rotate within said bowl.

Furthermore and in accordance with a preferred embodiment of the present invention, one of said plurality of utensils is a cutting and dispensing device that comprises a blade capable of rotating within the bowl and a dish mounted in said bowl having side openings through which appropriate sized particles can be dispensed of the dish.

Furthermore and in accordance with a preferred embodiment of the present invention, one of said plurality of utensils is a baby food maker capable of cutting food to an appropriate size and filtering the food during the process.

Furthermore and in accordance with a preferred embodiment of the present invention, said baby food maker comprises a blade positioned onto said shaft and a filter surrounding said blade.

Furthermore and in accordance with a preferred embodiment of the present invention, a support is provided within said filter.

Furthermore and in accordance with a preferred embodiment of the present invention, one of said plurality of utensils is a squeezer.

Furthermore and in accordance with a preferred embodiment of the present invention, said squeezer comprises a cylinder sized to be housed in said bowl having slits for guiding a disc having holes upwardly within said cylinder and a mechanism capable of upwardly guiding said disc.

Furthermore and in accordance with a preferred embodiment of the present invention, said mechanism is a ring sized to fit an upper portion of said cylinder and gear provided within said ring.

Furthermore and in accordance with a preferred embodiment of the present invention, one of said plurality of utensils is a cutting utensil.

Furthermore and in accordance with a preferred embodiment of the present invention, said cutting utensil comprises a cylinder sized to be housed in said bowl having slits for guiding a disc having a plurality of cutting blades upwardly within said cylinder and a mechanism capable of upwardly guiding said disc.

Furthermore and in accordance with a preferred embodiment of the present invention, said mechanism is a ring sized to fit an upper portion of said cylinder and gear provided within said ring.

Furthermore and in accordance with a preferred embodiment of the present invention, said cutting blades are arranged in a mesh form.

Furthermore and in accordance with a preferred embodiment of the present invention, said cutting blades are arranged in parallel rows.

Furthermore and in accordance with a preferred embodiment of the present invention, one of said plurality of utensils is a grater.

Furthermore and in accordance with a preferred embodiment of the present invention, said grater comprises an inner cone grate provided on said shaft and capable of being rotated and a outer grate that fits so be mounted on said base and wherein said inner cone grate is tapered.

Furthermore and in accordance with a preferred embodiment of the present invention, said cover is incorporated with other kitchen utensils so as to electrically operate them.

Furthermore and in accordance with a preferred embodiment of the present invention, said cover is operating a spinner that comprises a bowl and a drum wherein said drum is communicated with said cover so as to electrically sin the drum within the stationary bowl.

Furthermore and in accordance with a preferred embodiment of the present invention, said cover is operating another food processor wherein said cover transfers its motor power through a transferring unit.

### BRIEF DESCRIPTION OF THE FIGURES

In order to better understand the present invention and appreciate its practical applications, the following Figures are attached and referenced herein. Like components are denoted by like reference numerals.

It should be noted that the figures are given as examples and preferred embodiments only and in no way limit the scope of the present invention as defined in the appending Description and Claims.

FIG. 1 illustrates a universal bowl and a cover in accordance with a preferred embodiment of the present invention.

FIGS. 2a-m illustrate different utensils that are adapted to be incorporated within a universal food processor in accordance with preferred embodiments of the present invention.

FIG. 3 illustrates a citrus juicer in accordance with a preferred embodiment of the present invention.

FIG. 4 illustrates a salad spinner in accordance with a preferred embodiment of the present.invention.

FIG. 5 illustrates a food processor device operated by the cover portion in accordance with a preferred embodiment of the present invention.

### DETAILED DESCRIPTION OF THE INEVNTION AND FIGURES

The present invention provides a new and unique food processor apparatus that is compact and still can maintain most of the functionalities that are made in the kitchen. The apparatus is using the same engine and mostly the same bowl in order to accommodate different utensils that are adapted to address the different functionalities.

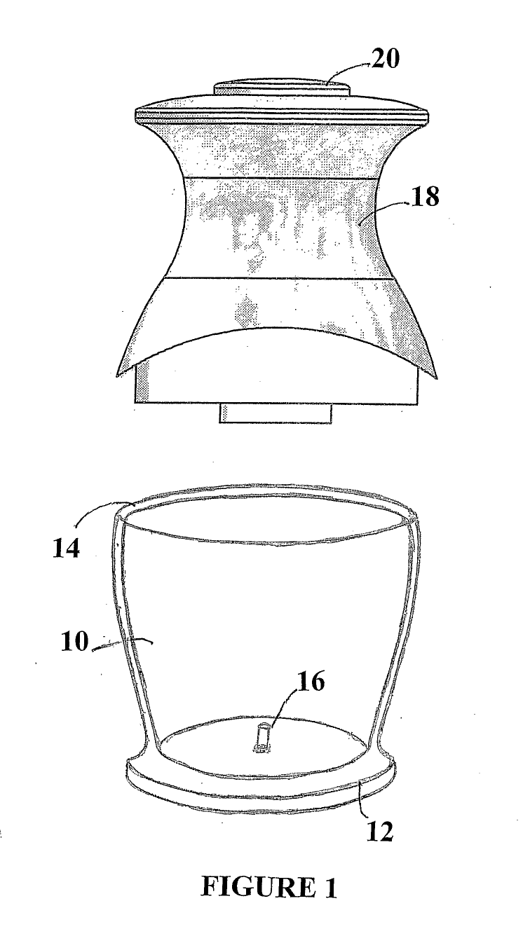

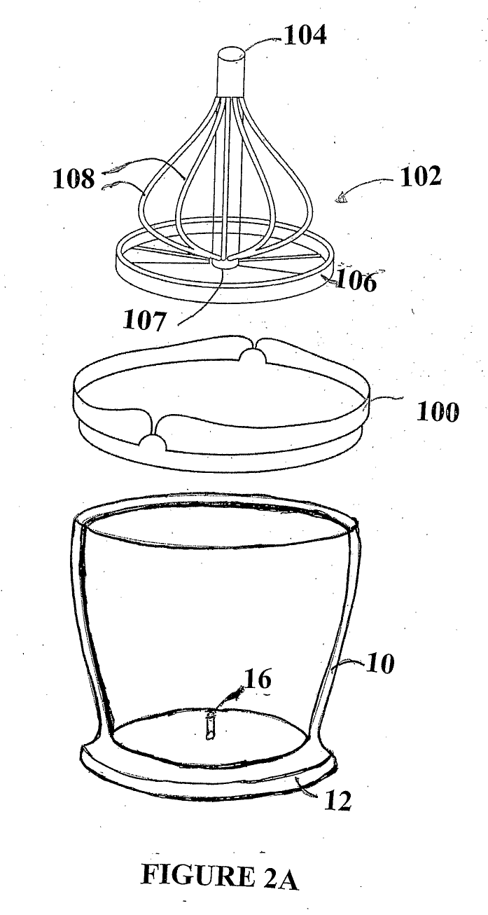

Reference is now made to FIG. 1 illustrating a universal bowl and a cover in accordance with a preferred embodiment of the present invention. Universal bowl 10 is a regular bowl having a base 12 and an upper opening 14. A stem 16 is provided substantially at the center of base 12 pointing upwardly. A cover 18 sized to fit opening 14 of universal bowl 10 is capable of closing the bowl in a manner that prevents fluid from easily pass through the opening. The opening can be provided with an o-ring that strengthens the closure between the bowl and the cover. A motor (not shown in the figures) is provided within cover 18 in its upper portion, wherein the motor can rotate a shaft that will be connected to cover 18, from within its interior side. A knob 20 is provided at the top of cover 18 that acts as an on-off knob that turns the motor on and off. It is possible to set several rotational velocities in the knob so as to enable changes in the rotation of the shaft that will be connected to the motor output.

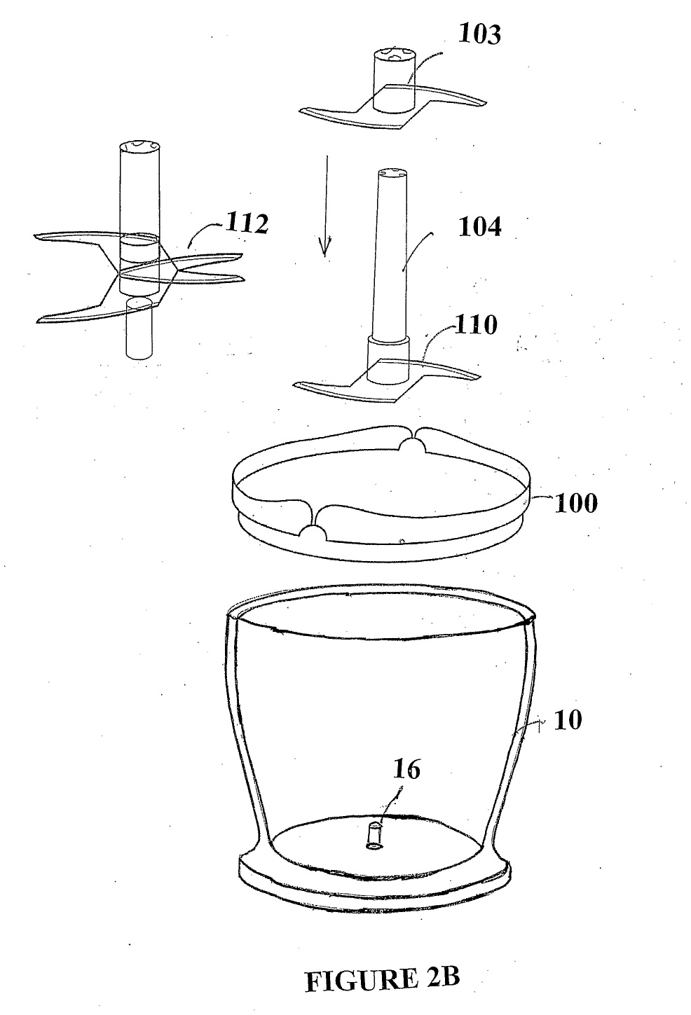

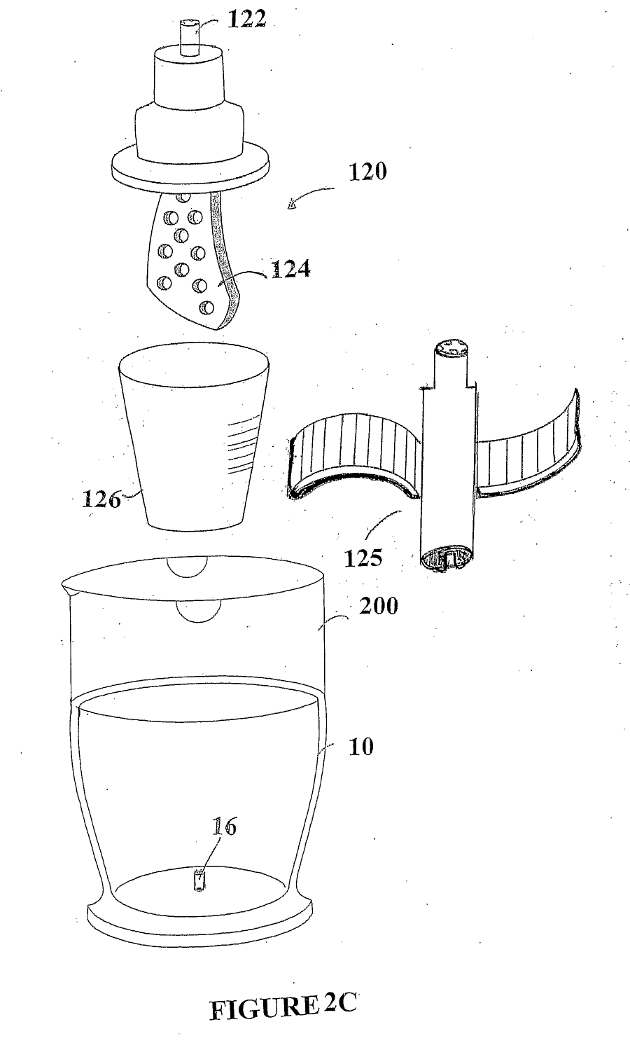

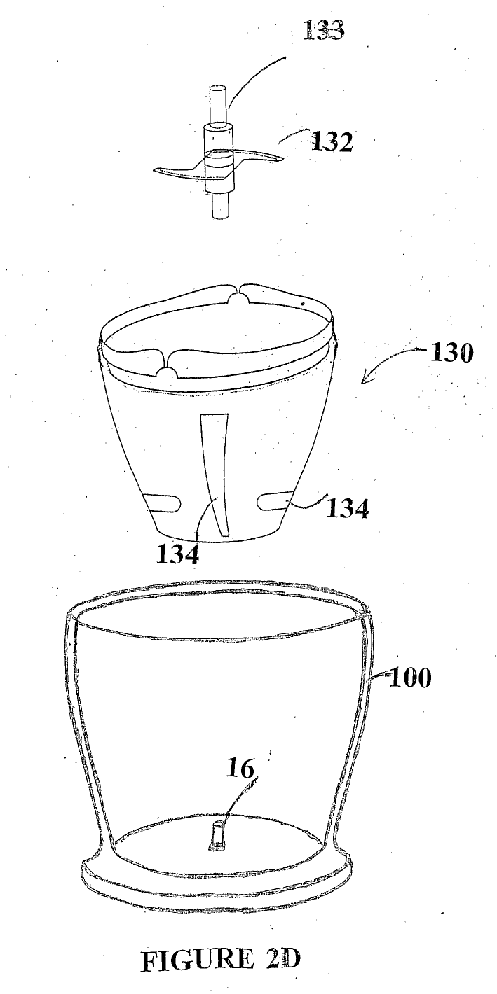

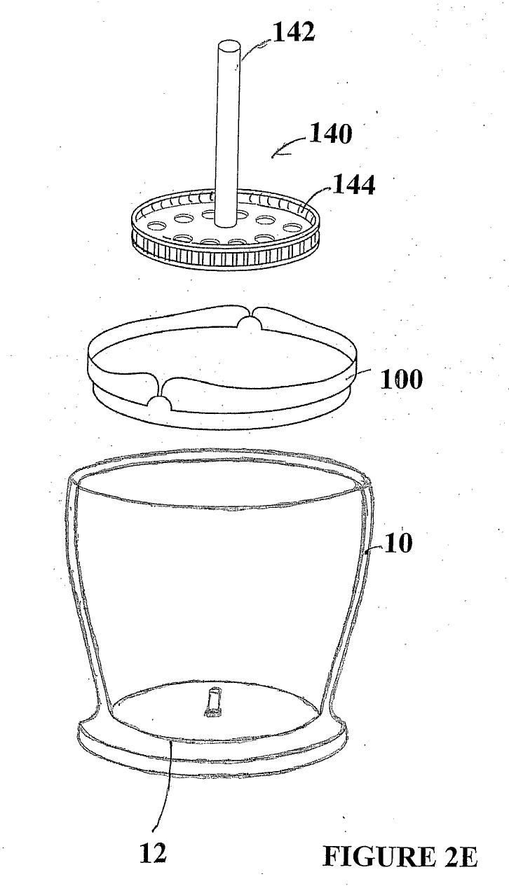

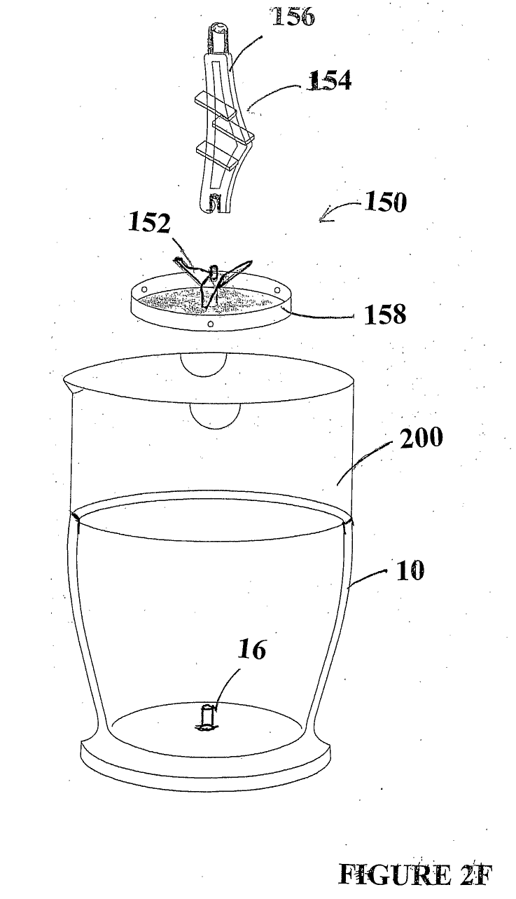

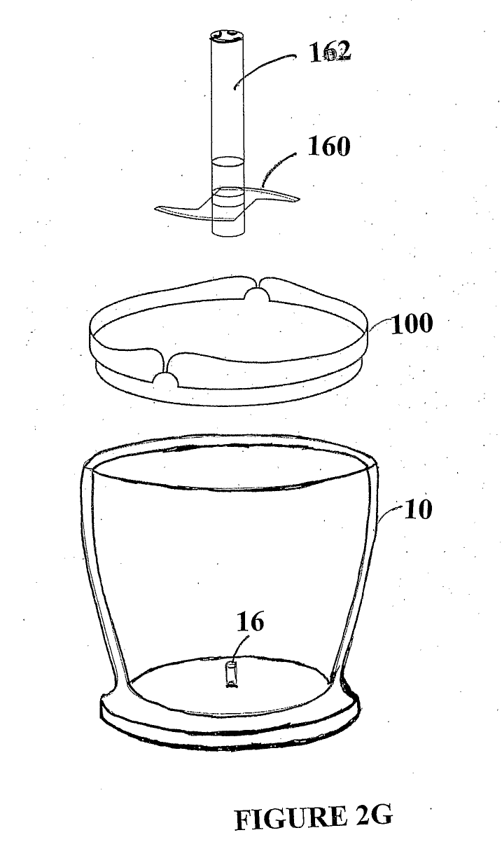

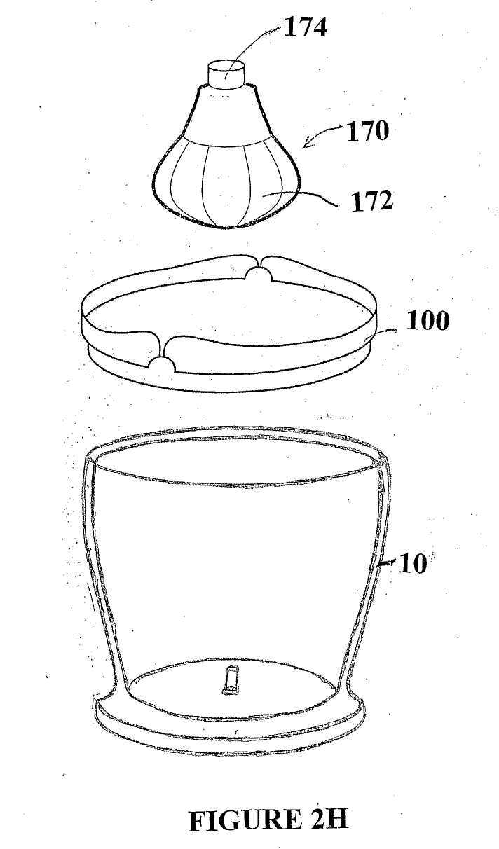

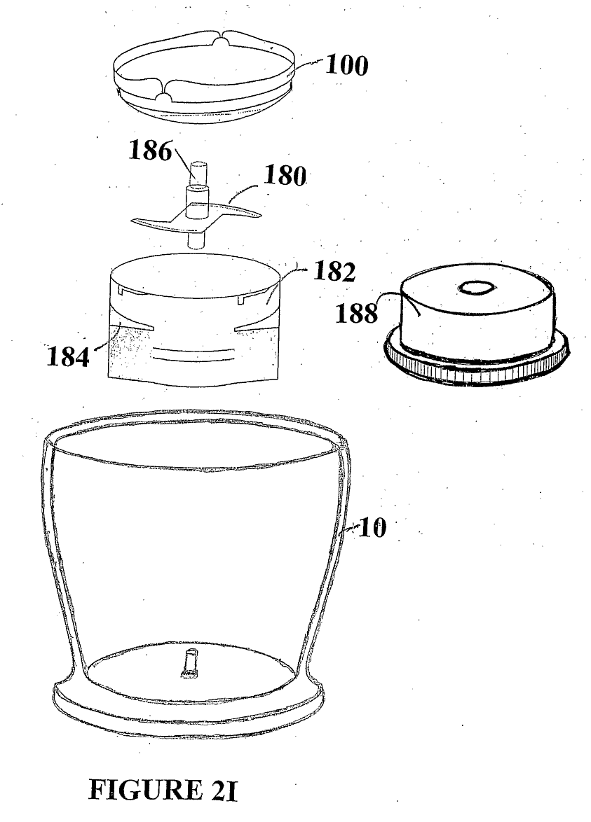

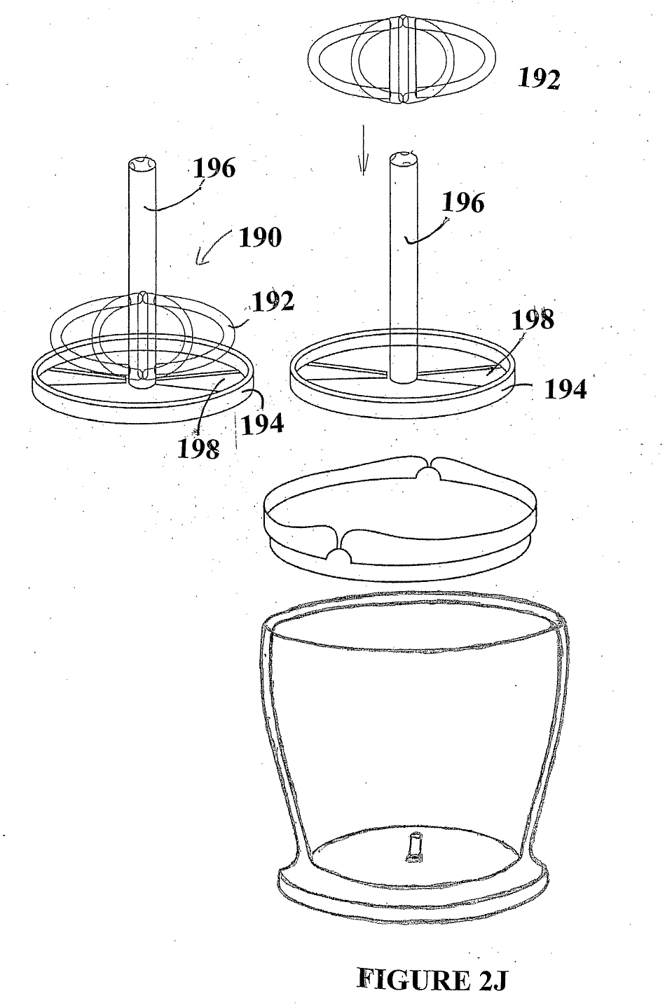

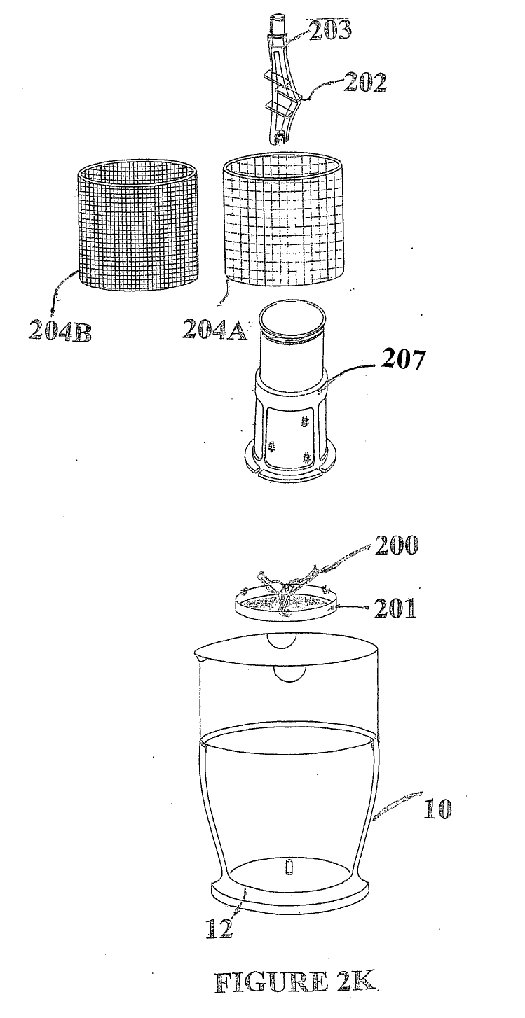

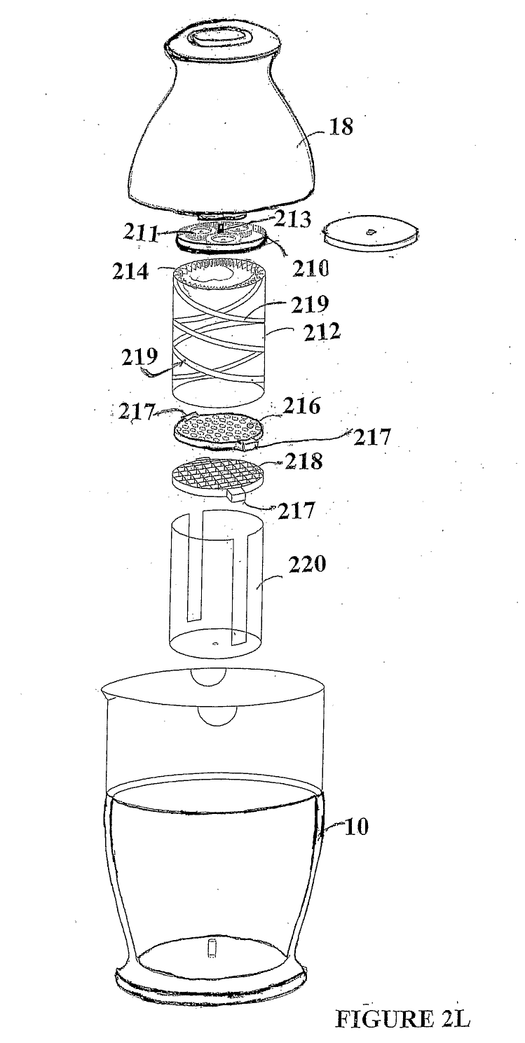

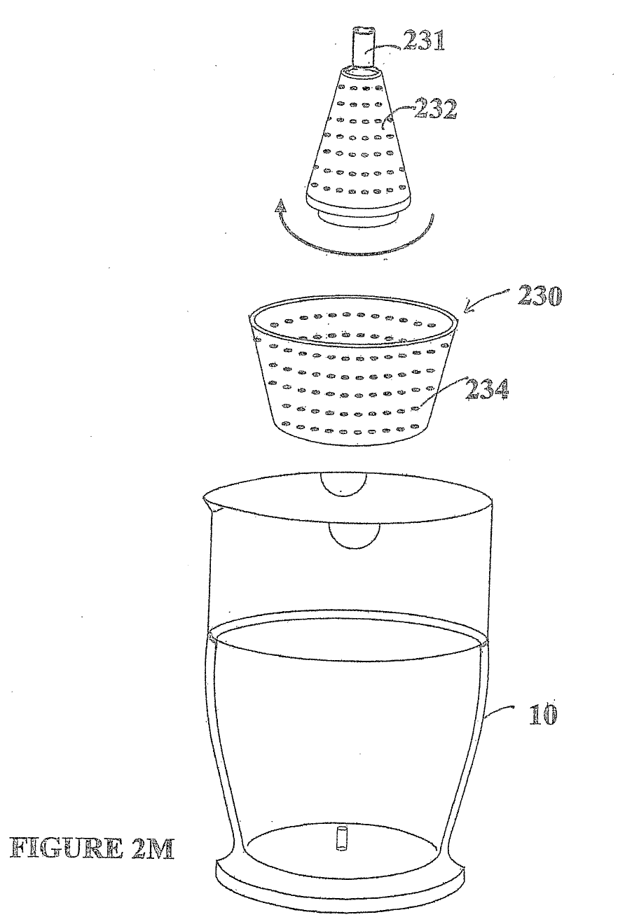

Reference is now made to FIGS. 2a-m illustrating different utensils that are adapted to be incorporated within a universal food processor in accordance with preferred embodiments of the present invention. Generally, the figures illustrate different utensils sized to be incorporated within and between the bowl and the cover and therefore have to be substantially centered within. Almost all utensils have a hole in the lower part that is adapted to receive stem 16 of the base of bowl 10 and a shaft at the upper end adapted to be connected internally and at the upper portion of cover 18 that is shown in FIG. 1. The shaft is capable of being rotated by the motor in the cover.

FIG. 2a illustrates an egg beater 102 in accordance with a preferred embodiment of the present invention that can be positioned within universal bowl 10. A shaft 104 is positioned to receive rotational power from the motor in the cover (the cover is not shown in this figure). The lower part 106 is placed on base 12 while a fitting hole 107 in the lower portion of shaft 104 is adapted to fit stem 16 so as to stabilize the utensil when operated. An adjustment ring 100 is preferably provided between the cover and bowl 10. Egg beater 102 is provided with a plurality of arcs 108 placed in a circle about shaft 104. In order to operate egg beater 102, the utensil is placed within bowl 10 that is covered by cover 18 (illustrated in FIG. 1) and rotated by shaft 104, The rotational movement of beater 102 and the arcs can cream any protein material such as eggs or cream that is placed within the bowl.

FIG. 2b illustrates a cutting blade 110 that is provided to shaft 104 preferably in its lower portion in accordance with a preferred embodiment of the present invention. The shaft and the blade is similarly put within the bowl pined on stem 16 in order to stabilize the shaft and the blade. The blade, when rotated, is adapted to chop meat or fish. Optionally, an additional blade 103 is placed on top of blade 110 so as to form combined blades 112 that are used in order to make the cutting process more efficient.

FIG. 2c illustrates a dasher 120 for making shakes in accordance with a preferred embodiment of the present invention. Dasher 120 is provided with a shaft 122 to be connected to the motor in the cover so as to rotate the dasher. Optionally, bowl 10 can be provided with an extension 200 adapted to enlarge the bowl so as to accommodate more food material. Dasher 120 is provided with a holed arm 124 that rotated and shakes the liquid that is placed within bowl 10.

Optionally, a dish 126 is provided and can be placed within bowl 10 fixed to it through stem 16 wherein dish 126 is sized to be smaller than bowl 10 and accommodate holed arm 124 so as to reduce the volume of material onto which arm 124 is operated in any time.

FIG. 2d illustrates an ice crusher 130 in accordance with a preferred embodiment of the present invention that is placed within universal bowl 10 while a blade 132 is provided inside the bowl and the ice crusher so as to crush ice that is placed within ice crusher. Blade 132 is placed on a shaft 133 that is rotated by the motor in the cover of the bowl. The ice that is crushed into an appropriate size is dispensed from ice crusher 130 through holes 134 into the space that is formed between the ice crusher and the exterior sides of the bowl.

FIG. 2e illustrates a milk creamer 140 in accordance with a preferred embodiment of the present invention that is placed similarly to the other utensils within bowl 10 and is also provided with a shaft 142 that is adapted to be connected to the motor in the cover of the food processor in order to be rotated. A holed disc 144 is placed in the bottom portion of shaft 142 wherein holed disc 144 is adapted to fit adjacent to base 12 of bowl 10. An adjusting ring 100 is optionally provided so as to firmly close the opening of the bowl. Milk that is placed within the bowl will be creamed by the rotational movement of holed disc 144.

FIG. 2f illustrates a blender assembly 150 in accordance with a preferred embodiment of the present invention that comprises a blending blade 152 that is placed in the bottom of bowl 10 onto stem 16. Blade 152 seats in a plate like member 158 so as to render stability to the blade. Rotating paddles 154 are provided to shaft 156, wherein paddles 154 are adapted to disrupt a layered flow of the mixture that is being mixed by the rotational movement of blade 152 and form an equally mixed mixture.

Optionally, an extension 200 to bowl 10 can be provided so as to enlarge the bowl to receive additional amounts of food material.

FIG. 2g illustrates a blade 160 in accordance with a preferred embodiment of the present invention that is adapted for chopping vegetables, nuts etc. Blade 160 is provided in a bottom portion of a shaft 162 that is fittingly sized to fit between stem 16 on the base of the bowl and the motor that is provided in the cover of the bowl as shown in FIG. 1. An adjusting ring 100 is optionally provided to be placed between the bowl and the cover.

FIG. 2h illustrates a garlic peeler 170 in accordance with a preferred embodiment of the present invention. Garlic peeler 170 comprises a balloon 172 preferably made of an abrasive surface that peels the garlic or the like when it is rotated within the bowl. Balloon 172 is connected to a shaft 174 adapted to fit to the motor in the cover of the bowl wherein the shaft is adapted to rotate balloon 172 within bowl 10. Balloon 172 is sized relative to the walls of bowl 10 so as to closely accommodate the garlic cloves. The peel or skin of the garlic cloves is peeled of by the friction that is imposed on the cloves by the rotating balloon. It should be mentioned that other foods can be peeled using this apparatus such as nuts.

The principle operation of such frictional wall on the garlic clove is comprehensively explained in PCT/IL2005/000826.

FIG. 2i illustrates a utensil for chopping and grinding herbs, spices, coffee beans, nuts and the like in accordance with a preferred embodiment of the present invention. The utensil comprises a blade 180 connected to a shaft 186 and an inner box 182 having slits 184 adapted to dispense the ready product. The operation of cutting and dispensing the material through holes in inner box 182 is similar to the operation of the ice crusher that is shown in FIG. 2d. It should be noted that optionally, a cover 188 can be provided to cover inner box 182 wherein in this case, the blades are operated within the box and the grinded material stays in the box rather than dispensed until the operation of the blade is stopped and the box is removed. In this way, the chopped material stays in the closed box. Bowl 10 in this case has a very minor function and act as a housing.

FIG. 2j illustrates a beater 190 in accordance with another preferred embodiment of the present invention adapted to mix chocolate powder to within milk. Beater 190 is similar to egg beater 102 shown in FIG. 2a; however, the plurality of arcs 192 are placed in the bottom portion of the utensil so as to be able to beat the powder better and to mix it within the milk. A disc like member 194 is provided at the bottom end of a shaft 196 wherein disc like member is provided with openings 196 that are also adapted to treat the powder that should be mixed and is concentrated at the beginning of the process in the bottom portion of the bowl.

To ease cleaning of the utensil, arcs 192 can be disassembled of shaft 196.

FIG. 2k illustrates a baby food maker in accordance with a preferred embodiment of the present invention. A blade 200 is provided to the lower portion of the bowl within a plate ring 201 that is placed on base 12 for stabilization. Paddles 202 are provided similarly as explained herein before on shaft 203. Several different meshed filters 204a and 204b are provided that are placed within bowl 10 and allows only certain sized food to be transferred to the outer portion of the filter, between the filter and the outer walls of the bowl. A housing 207 that can be mounted onto ring 201 can be used in order to support the meshed filters and to provide a close area in the vicinity of blade 200.

FIG. 2l illustrates a squeezer for fruits such as pomegranate or a chopper for onion as an example and in accordance with preferred embodiments of the present invention. FIG. 2l is an exploded view illustrating a member 210 that is connected to the motor in cover 18 and is preferably provided with 3 gears 211. Member 210 is adapted to be placed in the upper portion of a cylinder 212 having inner teeth 214 that correspond outer teeth of gears 211. When gears 211 are placed in the upper portion of cylinder 212 and rotated by the motor in the cover through shaft 213, cylinder 212 is rotated as a result. Changeable disc that can be a squeezing disc 216, a cutting disc 218, or alike is forced to withdraw from the lower portion to the upper portion of cylinder 212 while squeezing or cutting a pomegranate or onion, respectively, that is placed between the gears and the disc, in the cylinder. Discs 216 or 218 are provided with preferably opposite protrusions 217 that are placed within corresponding slits 219 that guide the disc to climb within cylinder 212. A member 220 is provided in order to accommodate and direct the discs.

FIG. 2m illustrates a cheese and chocolate grater in accordance with a preferred embodiment of the present invention. Cheese grater 230 is provided with two graters—an inner cone grate 232 and an outer oppositely arranged grate 234 that are forming together two opposite walls between which the cheese or chocolate pieces to be grated are placed. Inner cone grate 232 is provided with a shaft 231 that is adapted to receive rotational power from the motor that is placed within the cover. Outer grate 234 is stationary. The grater walls form a tapering structure through which the placed pieces that become smaller and smaller in their widths due to their being grated are forwarded downwardly between the two opposite walls while they are continued to being grated.

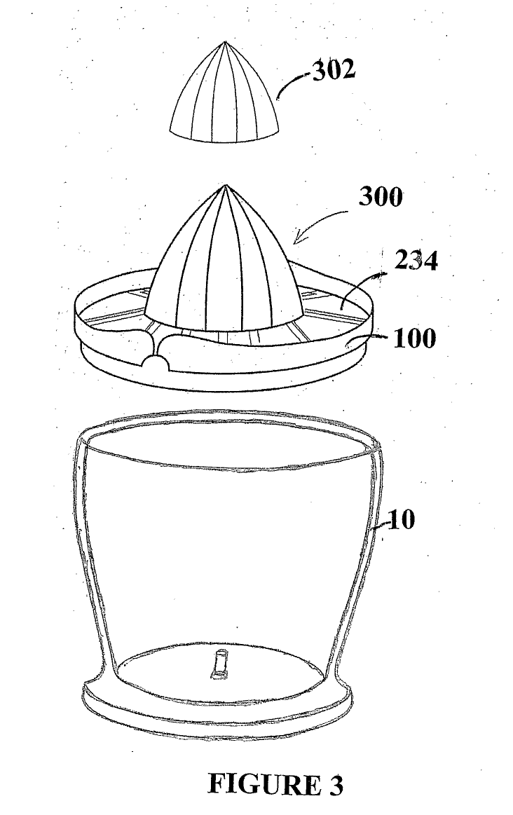

Reference is now made to FIG. 3 illustrating a citrus juicer in accordance with a preferred embodiment of the present invention. In this case, the upper cover is not necessary and the universal bowl is being used individually. Adjusting ring 100 is provided to accommodate a citrus juicer 300 or lemon squeezer 302. The juicer or squeezer are such as being used in the art; however, they are changeable and can be replaced on the base 234 that can be used for both.

It should be emphasized that the bowl and the cover are used with almost all utensils that are shown herein as different embodiments. The cover is provided with the motor to which a shaft of the utensil is attached and rotated by the motor and the bowl is stationary and has a centered stem adapted to receive a lower portion of the utensil. It should be clear that other utensils or differentiation of existing utensils can be incorporated and used in the apparatus of the present invention using the upper motor. Those utensils are covered by the scope of the present invention.

It is optional to use only the cover of the apparatus as a motor to utilize regular utilities in the kitchen in an electrical manner.

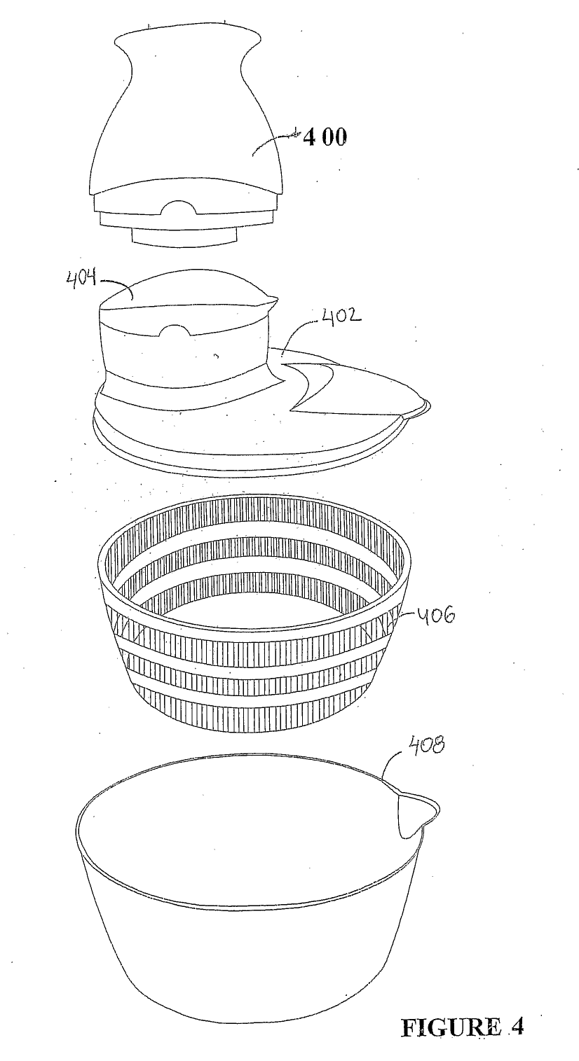

Reference is now made to FIG. 4 illustrating a salad spinner in accordance with a preferred embodiment of the present invention. The spinner portions—a bowl 408 and the drum 406 are the same as used in the industry, however, a top portion 402 I provided with a connector 404 to which a top cover 400 that is similar to cover 18 provided with a motor unit can be incorporated. Connector 404 is provided with gears (internal therefore not shown in the figure) that are transferring the power from the motor to the spinner in a manner that is known in the art.

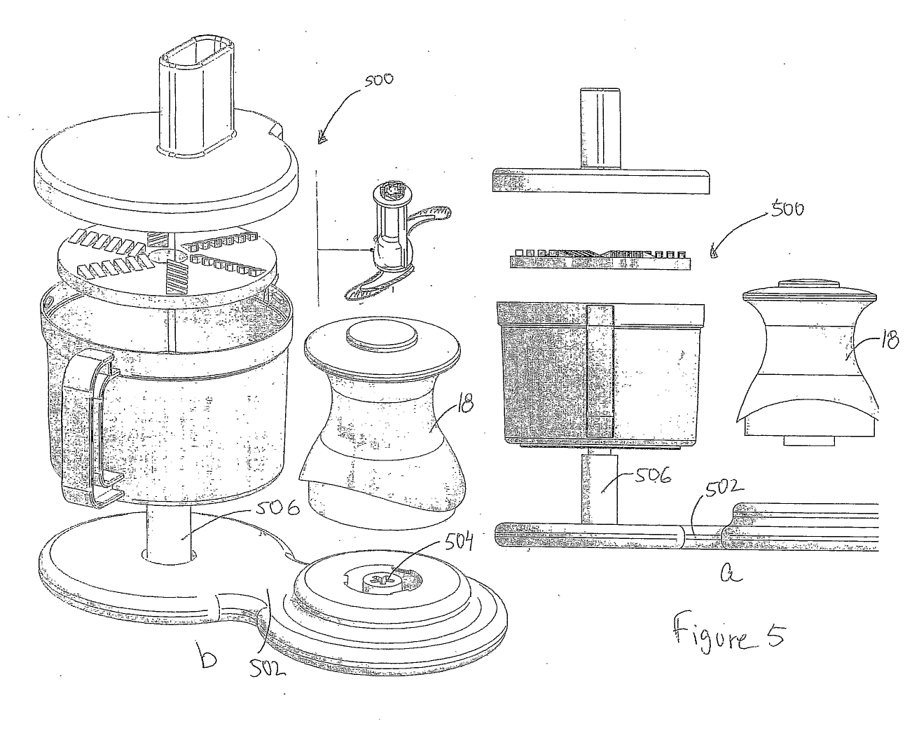

Reference is now made to FIG. 5 illustrating a food processor device operated by the cover portion in accordance with a preferred embodiment of the present invention. Unit 500 is a food processor provided with a bowl, a cover and several cutting utensils as known in the art. A transferring unit 502 is provided, wherein the food processor assembly 500 is placed in one side of transferring unit 502 and on the other side, a connector 504 is provided. The connector is capable of rotating using the motor that is placed within cover 18. Cover 18 is placed on top of transferring unit 502 and rotates connector 502. The rotational power is translated to rotational power on the other side of transferring unit 502 in order to rotate a shaft 506 that operated food processor unit 500. The apparatus is shown in side view a and an isometric view b in order to show the different features.

It should be clear that the description of the embodiments and attached Figures set forth in this specification serves only for a better understanding of the invention, without limiting its scope as covered by the following Claims.

It should also be clear that a person skilled in the art, after reading the present specification can make adjustments or amendments to the attached Figures and above described embodiments that would still be covered by the following Claims.

1. A multi-functional food processor comprising:
a bowl having an upper opening and a base;
a cover provided with a motor and having an opening sized to fit said upper opening;
a plurality of utensils, each of the utensils having a shaft capable of receiving rotational power from said motor and a lower portion capable to fit onto said base.

2. The food processor as claimed in claim 1, wherein said base is provided with a stem capable of receiving said lower portion of each one of said plurality of utensils.

3. The food processor as claimed in claim 1, wherein said cover is provided with an on/off knob that controls the motor's operation.

4. The food processor as claimed in claim 1, wherein an extension to said bowl is provided in order to enlarge the bowl volume.

5. The food processor as claimed in claim 1, wherein said lower portion is placed within a rounded plate fitting said base.

6. The food processor as claimed in claim 1, wherein one of said plurality of utensil is a beater comprising a plurality of arcs placed in a circular manner around said shaft.

7. The food processor as claimed in claim 1, wherein at least one cutting blade is provided to be installed on top of said lower portion of the shaft.

8. The food processor as claimed in claim 1, wherein one of said plurality of utensils is a dasher comprising a holed paddle.

9. The food processor as claimed in claim 8, wherein a dish is provided to said dasher and wherein said dish is shaped as a cup and fits said base.

10. The food processor as claimed in claim 1, wherein one of said plurality of utensils is an ice crusher that comprises a blade capable of rotating within the bowl and a dish mounted in said bowl having side openings through which appropriate sized ice particles can be dispensed of the dish.

11. The food processor as claimed in claim 1, wherein a holed disc is provided in the bottom of said shaft.

12. The food processor as claimed in claim 1, wherein at least one paddle is provided on said shaft.

13. The food processor as claimed in claim 1, wherein one of said plurality of utensils is a peeler capable of peeling a peel of a garlic clove or nuts.

14. The food processor as claimed in claim 13, wherein said peeler comprises a balloon provided with a friction wall is provided on said shaft and wherein said balloon can freely rotate within said bowl.

15. The food processor as claimed in claim 1, wherein one of said plurality of utensils is a cutting and dispensing device that comprises a blade capable of rotating within the bowl and a dish mounted in said bowl having side openings through which appropriate sized particles can be dispensed of the dish.

16. The food processor as claimed in claim 1, wherein one of said plurality of utensils is a baby food maker capable of cutting food to an appropriate size and filtering the food during the process.

17. The food processor as claimed in claim 16, wherein said baby food maker comprises a blade positioned onto said shaft and a filter surrounding said blade.

18. The food processor as claimed in claim 17, wherein a support is provided within said filter.

19. The food processor as claimed in claim 1, wherein one of said plurality of utensils is a squeezer.

20. The food processor as claimed in claim 19, wherein said squeezer comprises a cylinder sized to be housed in said bowl having slits for guiding a disc having holes upwardly within said cylinder and a mechanism capable of upwardly guiding said disc.

21. The food processor as claimed in claim 20, wherein said mechanism is a ring sized to fit an upper portion of said cylinder and gear provided within said ring.

22. The food processor as claimed in claim 1, wherein one of said plurality of utensils is a cutting utensil.

23. The food processor as claimed in claim 22, wherein said cutting utensil comprises a cylinder sized to be housed in said bowl having slits for guiding a disc having a plurality of cutting blades upwardly within said cylinder and a mechanism capable of upwardly guiding said disc.

24. The food processor as claimed in claim 23, wherein said mechanism is a ring sized to fit an upper portion of said cylinder and gear provided within said ring.

25. The food processor as claimed in claim 23, wherein said cutting blades are arranged in a mesh form.

26. The food processor as claimed in claim 23, wherein said cutting blades are arranged in parallel rows.

27. The food processor as claimed in claim 1, wherein one of said plurality of utensils is a grater.

28. The food processor as claimed in claim 27, wherein said grater comprises an inner cone grate provided on said shaft and capable of being rotated and a outer grate that fits so be mounted on said base and wherein said inner cone grate is tapered.

29. The food processor as claimed in claim 1, wherein said cover is incorporated with other kitchen utensils so as to electrically operate them.

30. The food processor as claimed in claim 29, wherein said cover is operating a spinner that comprises a bowl and a drum wherein said drum is communicated with said cover so as to electrically sin the drum within the stationary bowl.

31. The food processor as claimed in claim 29 wherein said cover is operating another food processor wherein said cover transfers its motor power through a transferring unit.

32. A universal food processor substantially as described in the above specification, attached Figures and appending Claims.
